(19) United States
(12) Patent Application Publication
(10) Pub. No.: US 2017/0003158 A1
(43) Pub. Date: Jan. 5, 2017

(54) FREQUENCY TEST METHOD OF AIRFLOW MACHINE

(71) Applicant: YOW JUNG ENTERPRISE CO., LTD., Kaohsiung City (TW)

(72) Inventor: SHUN-CHI HUANG, KAOHSIUNG CITY (TW)

(21) Appl. No.: 14/789,029

(22) Filed: Jul. 1, 2015

(51) Int. Cl. G01F 25/00

(52) U.S. Cl. CPC G01F 25/0053

(57) ABSTRACT

A frequency test method of an airflow machine for measuring flow data of an air flow meter is disclosed. A device under test is fixed on the airflow machine to test. In the frequency test method, a sampling program or a comparison program is chosen, and then a data is measured sequentially, which data comprises the value of static frequency, accelerating curve, air charge temperature, thermistor, atmospheric pressure, flow curve, and frequency amplitude, completing a frequency test procedure. Therefore, after the air flow meter is tested, the scale of the air flow meter is kept in standard scale to use.

### BACKGROUND OF THE INVENTION

Field of the Invention

The present invention relates a frequency test method of an airflow machine. More particularly, a test method for checking if every brand of the air flow meter meets a qualified value is disclosed, so that the scale of the air flow meter is kept in standard scale to use.

Description of Related Art

Fresh air passes through the air inlet duct, the air cleaner, and the throttle to move to the engine. The throttle is the accelerator, which is the only one mechanism in the whole engine controlled by the user. The traditional throttle comprises a main air inlet channel and a throttle valve controlled by a spring. When the driver does not step on the gas pedal, the throttle valve is closed to keep out the air. When the driver steps on the gas pedal, the spring of the throttle valve is pulled by a throttle cable to open the throttle valve, so that the air passes through the air inlet duct into the engine.

Besides, an air flow meter, also called as air flow sensor, is responsible for detecting the changes of the air flow and converting the changes to a voltage signal to send to the electronic control unit for determining the basic injection quantity. When the cleaning air corresponding to the load of the engine is supplied, the air flow meter directly and indirectly estimates the mass of the air, and the air is mixed with the gas to form an optimum mixture. However, after the air flow meter is produced, there is not a proper testing machine to precisely test whether the air flow meter meets the standard.

### SUMMARY OF THE INVENTION

Therefore, the object of the present invention is to provide a frequency test method of an airflow machine. More particularly, a test method for checking if every brand of the air flow meter meets a qualified value is disclosed, so that the scale of the air flow meter is kept in standard scale to use.

For the above object, a frequency test method of an airflow machine for measuring flow data of an air flow meter is disclosed. A device under test is fixed on the airflow machine to test. In the frequency test method, a sampling program or a comparison program is chosen, and then a data is measured sequentially, which data comprises the value of static frequency, accelerating curve, air charge temperature, thermistor, atmospheric pressure, flow curve, and frequency amplitude, completing a frequency test procedure. Therefore, after the air flow meter is tested, the scale of the air flow meter is kept in standard scale to use.

According to an embodiment, under the sampling program, after the inputting step, a multistage flow rate is set for measuring the data under different flow rate.

According to an embodiment, under the comparison program, a test mode or a batch/rework mode is chosen according to the amount of the air flow meter under testing.

According to an embodiment, under the test mode, after the inputting step, a measuring and comparison item is checked, and a parameter is set. After the comparison step, an error between a comparing data and a sampling data is calculated, and a report is printed.

According to an embodiment, under the batch/rework mode, after the inputting step, a serial number of a batch is inputted, and then a measuring and comparison item is checked and a parameter is set. After the comparison step, an error between a comparing data and a sampling data is calculated, and a report is printed.

According to an embodiment, under the batch/rework mode, the statistics and analysis of the measured data of the air flow meter under each serial number is processed and the statistics and analysis result is saved. Finally, a case report of the statistics and analysis result is printed According to an embodiment, every device under test (air flow meter) comprises a QR code for reading the testing data of the air flow meter immediately

### BRIEF DESCRIPTION OF THE DRAWINGS

FIG. 1A is a flow chart I of a frequency test method of an airflow machine according to the embodiment of the present invention;

FIG. 1B is a flow chart II of a frequency test method of an airflow machine according to the embodiment of the present invention;

FIG. 1C is a flow chart III of a frequency test method of an airflow machine according to the embodiment of the present invention; and

FIG. 2 is a screen display of a frequency test method of an airflow machine under a sampling program according to the embodiment of the present invention.

### DETAILED DESCRIPTION OF THE PREFERRED EMBODIMENT

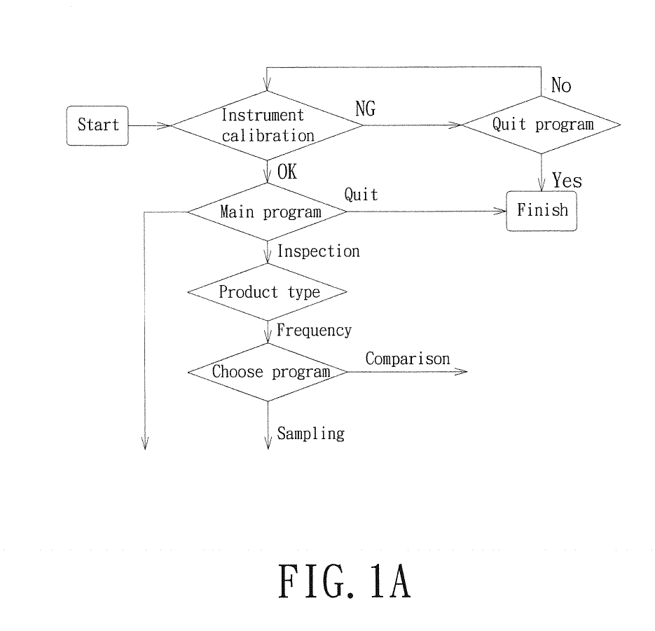

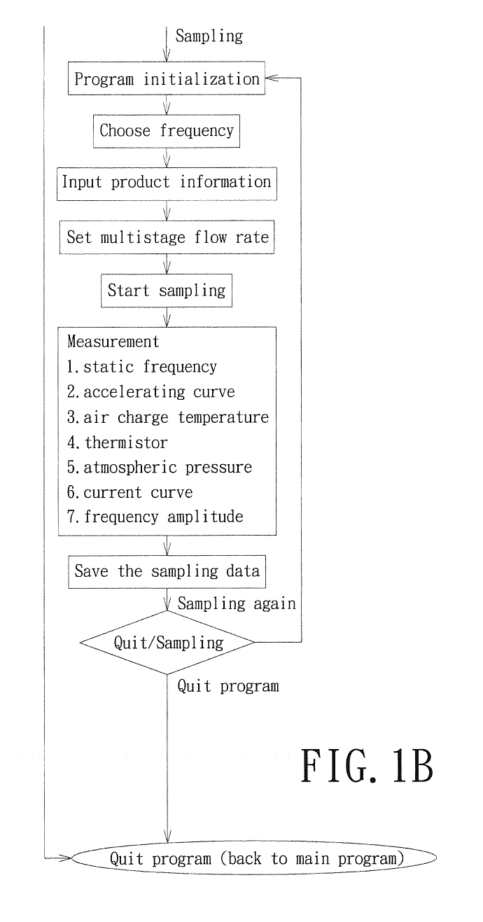

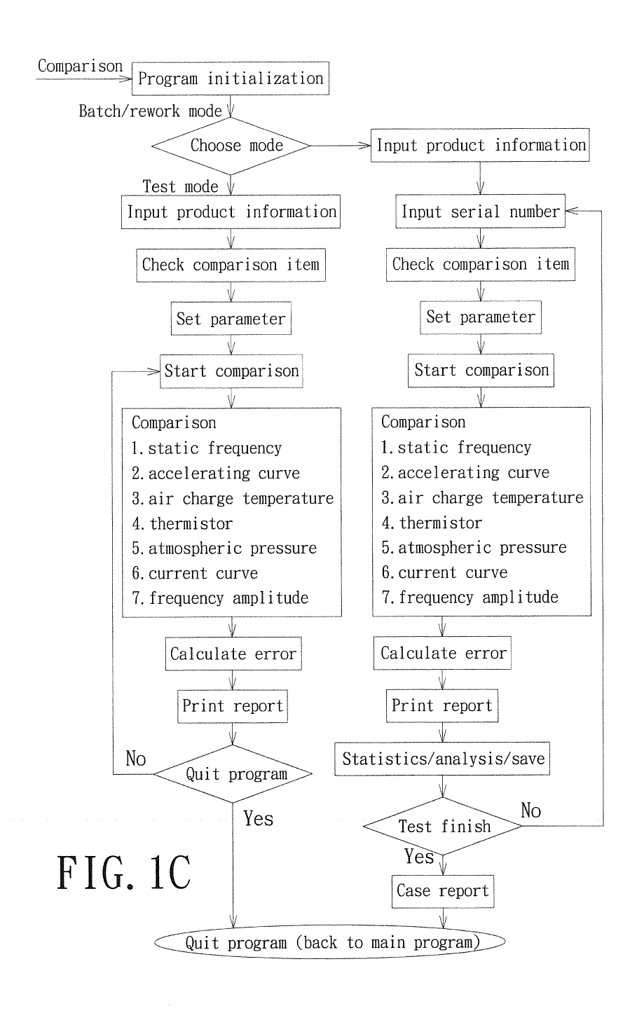

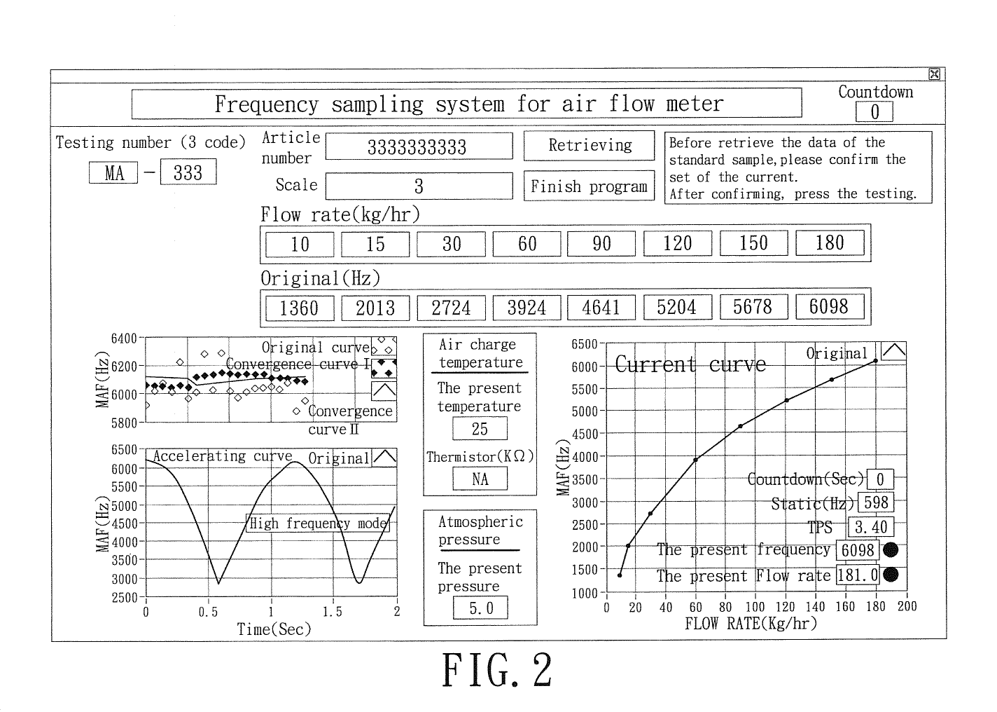

First, when a frequency test method is carried out, a device under test is fixed on an airflow machine. The airflow machine comprises a blowing apparatus, an air inlet duct, a throttle, a testing jig, a flow sensor, and a filter. The foregoing structure of the airflow machine is the same as the traditional airflow machine, so it is not described again. Please refer to FIG. 1A-1C and FIG. 2, which are a flow chart of a frequency test method of an airflow machine and a screen display of a frequency test method of an airflow machine under a sampling program according to the embodiment of the present invention. In detail, please refer to FIG. 1A, when a frequency test method of an airflow machine is carried out, a device under test is fixed on the testing jig of the airflow machine which is connected with a computer control system (not shown in the figure). When the test is started, a sampling program or a comparison program is chosen according to the device under test. If the device under test is an airflow machine having new specification, the sampling program is run (please refer to FIG. 1B). If the sampling data is already recorded in the computer control system, the comparison program is run. When the sampling program is run, the program is initialized first, and the information of the device under test is inputted into the computer control system. Then, a multistage flow rate is set for measuring the data under different flow rate. Next, the sampling is started. The air is sucked into the air inlet duct from the filter via the action of the blowing apparatus, and blades of the throttle are opened by the control of a motor. The volume of air inflow is proportional to the open angle of the blades. Moreover, the flow rate of air inflow is measured by the flow sensor, and data of static frequency, accelerating curve, air charge temperature, thermistor, atmospheric pressure, flow curve, and frequency amplitude of the device under test are measured sequentially. The function and safety of the vehicle influenced by the foregoing measuring items are described in Table 1.

TABLE 1

| Item | Object | Main Function | Abnormal Result |
|---|---|---|---|
| Static | Check the range | Electronic control | Abnormal static |
| frequency | of the static | unit receives the | frequency results |
| | frequency | signal of the static | that the engine |
| | | frequency to adjust | trembles seriously |
| | | the signal such as | or does not work; |
| | | idle air control | when the serious |
| | | (IAC) and | abnormal |
| | | electronic throttle | condition is |
| | | control (ETC) | happened, a |
| | | before the engine | malfunction |
| | | is started and | indicator lamp |
| | | during the engine | and a fault code |
| | | is starting. | of the air input |
| | | | system are |
| | | | displayed. |
| Acceleration | Mimic rapid | Use when rapid | The powerless of |
| curve | acceleration or | acceleration or | acceleration is |
| | deceleration of | deceleration of the | happened during |
| | the actual vehicle | vehicle, the | climbing or high |
| | and measure the | acceleration ability | speed, the control |
| | response speed of | during climbing or | time of enforced |
| | the product | high speed, and | kickdown |
| | | control the time of | operation is too |
| | | enforced kickdown | late, resulting in |
| | | operation | poor driveability |
| | | | and big trembles |
| | | | during the shift. |
| Air charge | Measure the air | Confirm that the | The difference |
| temperature | charge | environment | between the |
| | temperature and | temperature of the | environment |
| | record | airflow test | temperature of |
| | | machine during | the airflow test |
| | | sampling and | machine during |
| | | comparing is the | sampling and |
| | | same. | comparing leads |
| | | | to erroneous |
| | | | judgement of the |
| | | | system, resulting |
| | | | in engine tremble |
| | | | of the actual |
| | | | vehicle or display |
| | | | of the |
| | | | malfunction |
| | | | indicator lamp. |
| Thermistor | Check the | Electronic control | The fuel spray is |
| | function of the | unit receives the | excessive or |
| | thermistor | thermistor voltage | insufficient, and |
| | | to calculate the air | the malfunction |
| | | charge temperature | indicator lamp |
| | | in the air inlet duct, | and the fault code |
| | | so as to fine-tuning | of the intake |
| | | the signal of fuel | system are |
| | | spray of the engine | displayed. |
| | | due to the | |
| | | difference of the | |
| | | temperature and | |
| | | climate. | |
| Atmospheric | Check the | Electronic control | The fuel spray is |
| pressure | function of | unit receives the | excessive or |
| | detection of the | voltage to adjust | insufficient. The |
| | atmospheric | the signal of fuel | vehicle stalls and |
| | pressure | spray according to | trembles easily |
| | | the different | under idle RPM |
| | | atmospheric | and is not easy to |
| | | pressure, and the | start, and is |
| | | idle RPM is | powerless when |
| | | controlled by IAC | going on the |
| | | or ETC. | mountain road. |
| | | | When the serious |
| | | | abnormal |
| | | | condition is |
| | | | happened, the |
| | | | malfunction |
| | | | indicator lamp |
| | | | and a fault code |
| | | | of the air input |
| | | | system are |
| | | | displayed. |
| Flow curve | Mimic the | Electronic control | The serious |
| | condition of the | unit receives the | abnormal |
| | actual vehicle | voltage signal | condition results |
| | and check the | (frequency) to | that the operation |
| | signal | control the air flow | of start, idle, air |
| | corresponding to | from start to idle | conditioner, and |
| | idle, gear change, | and the air flow | drive are not |
| | air conditioner | under different | smooth. The fuel |
| | and different | speed such as low | spray is excessive |
| | speed such as | speed, medium | or insufficient, |
| | low speed, | speed, and high | and the flashover |
| | medium speed, | speed, so as to | time is too fast or |
| | and high speed. | control the engine | too slow. When |
| | | related elements | the serious |
| | | such as the fuel | abnormal |
| | | spray, the ignition | condition is |
| | | time, and the gear | happened, the |
| | | change time of the | malfunction |
| | | transmission. | indicator lamp |
| | | | and a fault code |
| | | | of air input, |
| | | | exhaust and |
| | | | engine system are |
| | | | displayed. |
| Frequency | Check the peak | Electronic control | The peak value is |
| amplitude | value of the | unit receives the | too low to read by |
| | frequency signal | peak value of the | the electronic |
| | | frequency to | control unit, |
| | | control the drive | resulting that the |
| | | signal from start to | engine does not |
| | | idle. | work or is not |
| | | | easy to start. The |
| | | | peak value is too |
| | | | high resulting that |
| | | | the short circuits |
| | | | of electronic |
| | | | control unit. |
| | | | When the serious |
| | | | abnormal |
| | | | condition is |
| | | | happened, the |
| | | | malfunction |
| | | | indicator lamp |
| | | | and a fault code |
| | | | of air input |
| | | | system are |
| | | | displayed. |

After the foregoing items are measured, the data is saved, and if the sampling step is not run again, the sampling program is quit. Otherwise, the sampling program is chosen again, and the sampling step is processed again according to the foregoing steps.

When a standard flow data of the air flow meter is set up in the computer control system according to the sampling data, the measuring data is compared with the standard data called out from the system in the comparison step. In detail, please refer to FIG. 1C, when the comparison program is chosen, a test mode or a batch/rework mode is chosen according to the amount of the device under test. If the device under test is single one, the test mode is chosen, and then the information of the device under test is inputted. According to the items of the flow rate which is need to measure, the comparison items are checked, and then the parameter is set. Next, the comparison step is started. The air is sucked into the air inlet duct from the filter via the action of the blowing apparatus, and blades of the throttle are opened by the control of a motor. The volume of air inflow is proportional to the open angle of the blades. The flow rate of air inflow is measured by the flow sensor, and data of static frequency, accelerating curve, air charge temperature, thermistor, atmospheric pressure, flow curve, and frequency amplitude of the device under test are measured sequentially. The object, the function, and the abnormal results of the measuring items are mentioned previously. The measuring data is compared with the sampling data, and an error between a comparing data and a sampling data is calculated after the comparison step. Finally, the report is printed. After printing, if the comparison step under the test mode is not run again, the program is quit. Otherwise, the comparison step under the test mode is chosen again, and the comparison step is processed again according to the foregoing steps.

Please refer to FIG. 1C, if the device under test is in large quantities, the batch/rework mode is chosen, and then the information and the serial number of the device under test are inputted. According to the items of the flow rate which is need to measure, the comparison items are checked, and then the parameter is set. Next, the comparison step is started. The air is sucked into the air inlet duct from the filter via the action of the blowing apparatus, and blades of the throttle are opened by the control of a motor. The volume of air inflow is proportional to the open angle of the blades. The flow rate of air inflow is measured by the flow sensor, and data of static frequency, accelerating curve, air charge temperature, thermistor, atmospheric pressure, flow curve, and frequency amplitude of the device under test are measured sequentially. After the measuring data is compared with the sampling data, an error between a comparing data and a sampling data is calculated, and the report is printed. Finally, statistics and analysis of the measuring data of the air flow meter under every serial number are processed, and then the statistics and analysis results are saved. After the batch measurement is completed, if the batch/rework mode is not run again, the case report of the statistics and analysis result is printed and the program is quit. Otherwise, the comparison step under the batch/rework mode is chosen again, and the comparison step is processed again according to the foregoing steps.

Furthermore, whether the flow data of the device under test meets the standard, all data are recorded in the data of its serial number, and each air flow meter comprises a QR code for reading the testing data of the air flow meter immediately. Moreover, when the device under test does not meet the standard, the data recorded in the QR code could be called out as the adjustment basis.

What is claimed is:

1. A frequency test method of an airflow machine for measuring flow data of an air flow meter, the frequency test method comprising the step of:
choosing a sampling program or a comparison program;
inputting a product information;
starting sampling or comparison, wherein data of static frequency, accelerating curve, air charge temperature, thermistor, atmospheric pressure, flow curve, and frequency amplitude are measured or compared sequentially; and
saving and printing the data.

2. The frequency test method of the airflow machine according to claim 1, under the sampling program, after the inputting step further comprising the step of:
setting multistage flow rate for measuring the data under different flow rate.

3. The frequency test method of the airflow machine according to claim 1, under the comparison program, further comprising the step of:
choosing a test mode or a batch/rework mode according to the amount of the air flow meter under testing.

4. The frequency test method of the airflow machine according to claim 3, under the test mode, after the inputting step further comprising the step of:
checking a measuring and comparison item;
setting a parameter;
calculating an error between a comparing data and a sampling data after the comparison step; and
printing a report.

5. The frequency test method of the airflow machine according to claim 3, under the batch/rework mode, after inputting step further comprising the step of:
inputting a serial number of a batch;
checking a measuring and comparison item;
setting a parameter;
calculating an error between a comparing data and a sampling data after the comparison step; and
printing a report.

6. The frequency test method of the airflow machine according to claim 5, under the batch/rework mode, further comprising the step of:
processing statistics and analysis of the measured data of the air flow meter under each serial number;
saving the statistics and analysis result after the processing step; and
printing a case report of the statistics and analysis result.

7. The frequency test method of an airflow machine according to claim 6, wherein each air flow meter comprises a QR code for reading the testing data of the air flow meter immediately.
